(19) United States
(12) Patent Application Publication
(10) Pub. No.: US 2007/0150766 A1
(43) Pub. Date: Jun. 28, 2007

(54) Information processing apparatus including network controller, and method of controlling application of power supply voltage to the network controller

(76) Inventor: Kazuyoshi Kuwahara, Akiruno-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/638,773

(22) Filed: Dec. 14, 2006

(30) Foreign Application Priority Data
Dec. 22, 2005 (JP) 2005-369479

(51) Int. Cl. G06F 1/00

(52) U.S. Cl. 713/300

(57) ABSTRACT

According to one embodiment, a power supply circuit normally generates a plurality of power supply voltages, which are to be used in an information processing apparatus, from a direct-current power supply voltage generated from an alternating-current power supply by an alternating-current adapter and generates the power supply voltages from a battery power supply when the alternating-current power supply is shut off. The power supply voltages include a specific power supply voltage to be used in a network controller. A power supply controller controls the power supply circuit to inhibit the specific power supply voltage from being applied to the network controller if the alternating-current power supply is shut off while a system operating state of the information processing apparatus is one of a sleep state and a shutdown state.

### CROSS-REFERENCE TO RELATED APPLICATIONS

This application is based upon and claims the benefit of priority from Japanese Patent Application No. 2005-369479, filed Dec. 22, 2005, the entire contents of which are incorporated herein by reference.

### BACKGROUND

1. Field

One embodiment of the invention relates to an information processing apparatus including a network controller, and a method of controlling the application of a power supply voltage to the network controller of the information processing apparatus.

2. Description of the Related Art

Most information processing apparatuses like a personal computer include a network controller. Some of the information processing apparatuses recently have a system management function of setting a network controller in an always ON state (active state) even in a sleep state or shutdown state. The system administrator can always operate an information processing apparatus with the system management function by remote control from a console for system managements (system management console) connected to the information processing apparatus via the network.

The Wake-On-LAN (WOL) function is known as the same function as the system management function. This WOL function is also called a remote wakeup function. The network controller of an information processing apparatus with the WOL function is set in an always ON state. The network controller receives a specific packet via a network and turns on the power supply of the information processing apparatus. Jpn. Pat. Appln. KOKAI Publication No. 8-314588 (referred to as prior art document hereinafter) discloses an information processing apparatus having a WOL function as described above. The information processing apparatus disclosed in the prior art document has different power-saving modes corresponding to the forms of access from a network in order to save the power of a battery built in the apparatus.

Most information processing apparatuses having a system management function or a WOL function are desktop personal computers that are driven by an alternating-current (AC) power supply. However, a notebook personal computer as well as the information processing apparatus disclosed in the prior art document has recently incorporated the above system management function or WOL function.

The notebook personal computer is not necessarily driven by the AC power supply, but can be driven only by a battery (battery power supply) depending on its use environment. According to the power-saving control technique (prior art) disclosed in the above prior art document, however, the network controller is set in an always active state even though the notebook personal computer is driven by the battery. In the prior art, when a notebook personal computer is driven by a battery, the battery supplies power to the network controller at all times. A considerable amount of power is therefore consumed by the network controller to shorten the connect time of the battery.

### BRIEF DESCRIPTION OF THE SEVERAL VIEWS OF THE DRAWINGS

A general architecture that implements various features of the invention will now be described with reference to the drawings. The drawings and their associated descriptions are provided to illustrate the embodiments of the invention and not to limit the scope of the invention.

FIG. 1 is a block diagram showing an exemplary system configuration of a notebook personal computer according to an embodiment of the invention;

FIG. 2 is a block diagram showing an exemplary configuration of a power supply circuit of the computer of FIG. 1 in association with a peripheral circuit of the power supply circuit;

FIG. 3 is a block diagram of an exemplary configuration of a network system incorporating the computer shown in FIG. 1;

FIG. 4 is a table showing an exemplary relationship among the operation of each of the system power supply unit, auxiliary standby power supply unit, and standby power supply unit of the power supply circuit shown in FIG. 2, the operating state of the system as a condition for operating these units, and the operating state of the system management function as a condition for operating these units;

FIG. 5 is a flowchart showing an exemplary procedure of a controller IC, which is executed when the input of AC power is shut off; and

FIG. 6 is a flowchart showing an exemplary procedure of the controller IC, which is executed when the input of AC power is resumed.

### DETAILED DESCRIPTION

Various embodiments according to the invention will be described hereinafter with reference to the accompanying drawings. In general, according to one embodiment of the invention, there is provided an information processing apparatus including a network controller. The information processing apparatus comprises a power supply circuit and a power supply controller. The power supply circuit is configured to normally generate a plurality of power supply voltages, which are to be used in the information processing apparatus, from a direct-current power supply voltage generated from an alternating-current power supply by an alternating-current adapter and to generate the power supply voltages from a battery power supply when the alternating-current power supply is shut off. The power supply voltages include a specific power supply voltage to be used in the network controller. The power supply controller is configured to control the power supply circuit to inhibit the specific power supply voltage from being applied to the network controller if the alternating-current power supply is shut off while a system operating state of the information processing apparatus is one of a sleep state and a shutdown state.

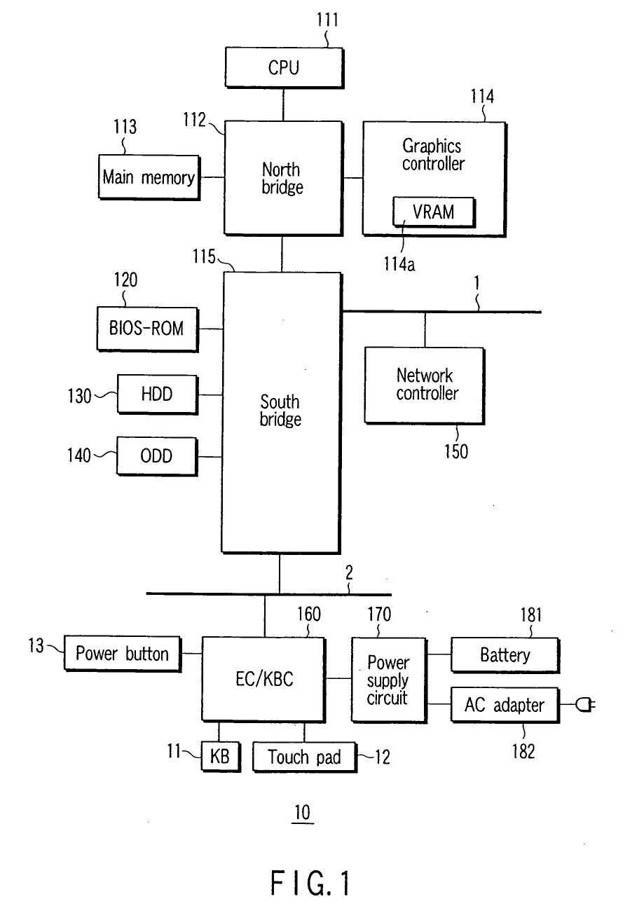

Referring first to FIG. 1, the system configuration of an information processing apparatus according to an embodiment will be described. The information processing apparatus is implemented as, for example, a notebook personal computer 10.

As shown in FIG. 1, the computer 10 includes a CPU 111, a north bridge 112, a main memory 113, a graphics controller 114 and a south bridge 115. The computer 10 also includes a BIOS-ROM 120, a hard disk drive (HDD) 130, an optical disk drive (ODD) 140, a network controller 150, an embedded controller/keyboard controller IC (EC/KBC) 160 and a power supply circuit 170.

The CPU 111 is a processor that controls the operation of the computer 10. The CPU 111 executes an operating system (OS) and various application programs. The operating system (OS) and application programs are loaded into the main memory 113 from the HDD 130. The CPU 111 also executes a Basic Input/Output System (BIOS) stored in the BIOS-ROM 120. The BIOS is a program for control of hardware.

The north bridge 112 is a bridge device which connects the local bus of the CPU 111 and the south bridge 115. The north bridge 112 incorporates a memory controller that controls access to the main memory 113. The north bridge 112 also has a function of communicating with the graphics controller 114 via an Accelerated Graphics Port (AGP) bus and the like.

The graphics controller 114 serves as a display controller and controls the LCD 17 used as a display monitor of the computer 10. The graphics controller 114 has a video memory (VRAM) 114a. The graphics controller 114 generates a video signal for forming a display image from the display data written into the VRAM 114a. The display image is to be displayed on the LCD 17.

The south bridge 115 controls access to the BIOS-ROM 120. The BIOS-ROM 120 is a rewritable nonvolatile memory such as a flash ROM. As described above, the BIOS-ROM 120 stores the BIOS. The south bridge 115 controls a disk drive (I/O device) such as the HDD 130 and the ODD 140. The south bridge 115 is connected to a Peripheral Component Interconnect (PCI) bus 1 and a Low Pin Count (LPC) bus 2. The south bridge 115 controls each device on the PCI bus 1 and LPC bus 2.

The HDD 130 is a storage device which stores various types of software and data. The HDD 130 reads/writes data from/to a magnetic recording medium (magnetic disk) through a head (magnetic head). The magnetic recording medium is rotated by a motor. The HDD 130 stores the operating system (OS) in advance. The OS is loaded into the main memory 113 in accordance with the BIOS stored in the BIOS-ROM 120 and executed by the CPU 111.

The ODD 140 is a drive unit which rotates an optical recording medium (optical disc) such as a compact disc (CD) and a digital versatile disc (DVD) through a motor. The ODD 140 reads/writes data from/to the optical disc through a head (optical head).

The network controller 150 serves as a LAN controller and is connected to the PCI bus 1. The PCI bus 1 can be replaced with a PCI express bus.

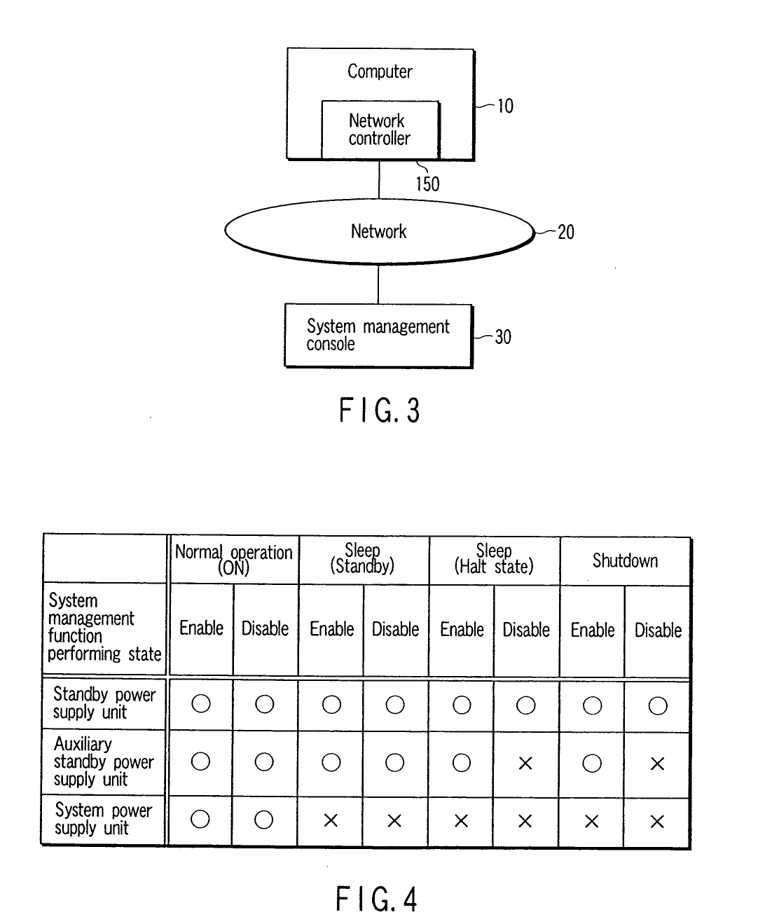

The network controller 150 is used to connect the computer 10 to a network 20 (see FIG. 3). The network controller 150 supports at least one of a Wake-On-LAN function and a system management function. The Wake-On-LAN function allows the computer 10 to be powered on through the network 20 when the network controller 150 is in an ON state (active state). In this embodiment, the computer 10 is powered on through the network 20 by a system management console 30 (see FIG. 3) which is connected to the network 20. The system management function allows the computer 10 to be operated by remote control from, for example, the system management console 30 through the network 20 when the network controller 150 is in an ON (active) state. The network controller 150 can be replaced with a wireless network controller.

The EC/KBC 160 is a microcomputer in which an embedded controller (EC) for managing a power supply and a keyboard controller (KBC) for controlling a keyboard (KB) 11 and a touch pad 12 are integrated on a single chip. The EC/KBC 160 has a power control function of operating in cooperation with the power supply circuit 170 and powering on/off the computer 10 in response to a user's depression of a power button 13. More specifically, the EC/KBC 160 controls the ON/OFF of a system power supply unit 171 and an auxiliary standby power supply unit 172 (both described later) of the power supply circuit 170. In this respect, the EC/KBC 160 can be regarded as a power supply control microcomputer (power supply controller).

The power supply circuit 170 generates a power supply voltage which is to be applied to each of the units of the computer 10, using a direct-current (DC) voltage that is applied from a rechargeable battery 181 or an AC adapter 182. The AC adapter 182 includes an AC-DC converter which transforms a commercial AC power supply voltage into a given DC power supply voltage.

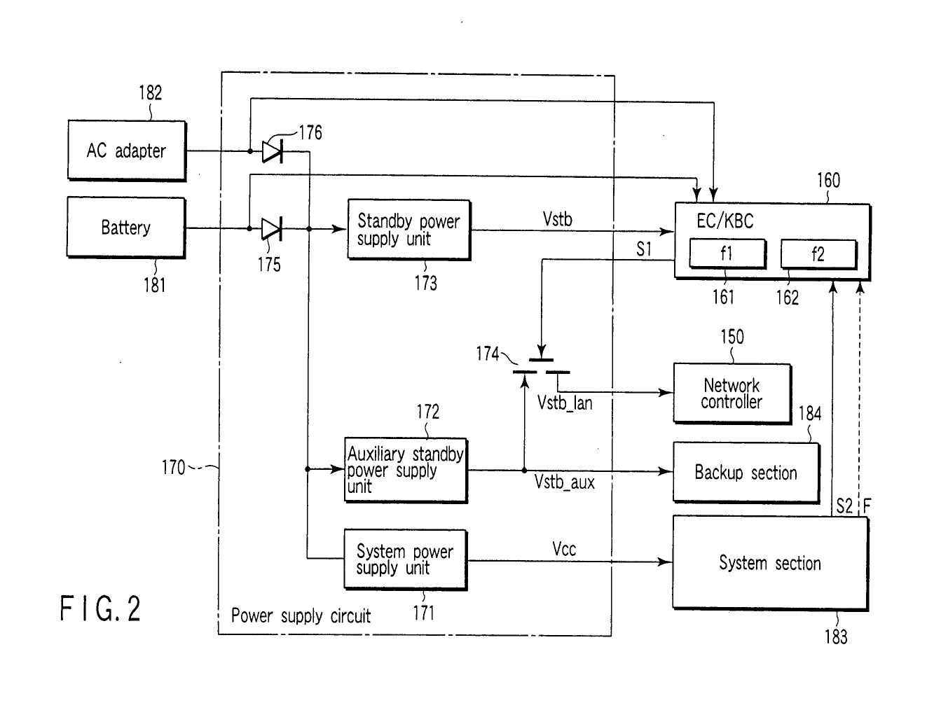

FIG. 2 is a block diagram showing a configuration of the power supply circuit 170 of FIG. 1 in association with a peripheral circuit of the power supply circuit 170. The power supply circuit 170 includes a system power supply unit 171, an auxiliary standby power supply unit 172, a standby power supply unit 173, a switch 174 and backflow-prevention diodes 175 and 176.

The output (positive electrode) of the battery 181 is connected to the anode of the diode 175, while the output (positive electrode) of the AC adapter 182 is connected to the anode of the diode 176. The cathodes of the diodes 175 and 176 are connected to the inputs of the system power supply unit 171, auxiliary standby power supply unit 172 and standby power supply unit 173.

When no AC power supply is connected to the power supply circuit 170 (computer 10) via the AC adapter 172 (i.e., when the AC power supply is shut off), a DC power supply voltage is applied from the battery 181 to the power supply units 171 to 173 via the diode 175. On the other hand, when an AC power supply is connected to the power supply circuit 170 (computer 10) via the AC adapter 172, a DC power supply voltage is applied from the AC adapter 182 to the power supply units 171 to 173 via the diode 176. The power supply units 171 to 173 are DC-DC converters which transform the DC power supply voltage, which is applied from the battery 181 or AC adapter 182, into DC power supply voltages of a given level.

The system power supply unit 171 operates in the normal operating state (normal operating mode) in which the operating state (system operating state, or system operating mode) of the computer (system) 10 is neither a sleep state (sleep mode) nor a shutdown state (shutdown mode). The system power supply unit 171 transforms a voltage applied from the battery 181 or AC adapter 182 into a system power supply voltage Vcc of a given level. The power-on state of the computer 10 indicates that the system power supply unit 171 is operating. In other words, the normal operating state means the power-on state of the computer 10.

The system power supply voltage Vcc output from the system power supply unit 171 is applied to a system unit 183. The system unit 183 includes the CPU 111, north bridge 112 and south bridge 115, which are shown in FIG. 1. The CPU 111, north bridge 112 and south bridge 115 are driven by the system power supply voltage Vcc.

The system unit 183 notifies the EC/KBC 160 of a system operating state, such as a normal operating state, a sleep (standby) state, a sleep (halt) state, and a shutdown state, using a control signal S2. Assume that the control signal S2 is generated by the CPU 111 in the system unit 183. In other words, the CPU 111 has a first state notification function of notifying the EC/KBC 160 of the system operating state using the control signal S2.

The system unit 183 also notifies the EC/KBC 160 whether the operation of the Wake-On-LAN function or the system management function is enabled or disabled, using, e.g., information F. The information F is generated by the OS when the Wake-On-LAN function or the system management function is enabled or disabled. The enabling state of the Wake-On-LAN function or the system management function indicates that the network controller 150 can be used, whereas the disabling state thereof indicates that the network controller 150 cannot be used. The OS is executed by the CPU 111 in the system unit 183. The generated information F is sent to the EC/KBC 160 via the BIOS. In other words, the CPU 111 has a second state notification function of notifying the EC/KBC 160 of the enabling or disabling state (operating state) of the Wake-On-LAN function or system management function using information F. For the sake of brevity, assume that the network controller 150 supports only the system management function in the following description.

The sleep state (sleep mode), which is one of the system operating states (operating modes), is roughly divided into a standby state (standby mode) and a halt state (halt mode). The difference between the standby mode and the halt mode is as follows. In the standby mode, in order to wake up the system (computer 10) quickly and return it to the state just before the system sleeps, the contents of the main memory 113 at the time of sleeping are maintained therein as they are. In the halt mode (a so-called hibernation mode), the contents of the main memory 113 at the time of sleeping are saved in a nonvolatile storage unit such as the HDD 130. In order to wake up the system from the halt mode, the contents saved in the HDD 130 have to be loaded into the main memory 113. For this reason, the halt mode in the present embodiment is regarded as the same as the shutdown mode in terms of hardware.

The auxiliary standby power supply unit 172 operates when the computer (system) 10 is in normal operating mode and when it is in sleep mode. If, however, the system management function is disabled when the sleep mode is a halt mode, the auxiliary standby power supply unit 172 does not operate. If the system management function is enabled even when the computer 10 is in shutdown mode, the auxiliary standby power supply unit 172 operates.

The auxiliary standby power supply unit 172 transforms a voltage, which is applied from the battery 181 or AC adapter 182, into an auxiliary standby power supply voltage Vstb_aux of a given level. This auxiliary standby power supply voltage Vstb_aux is applied to a backup unit 184. The backup unit 184 includes an element, such as the main memory 113, which is required to wake up the system quickly from the sleep state and return it to a state just before the system sleeps. The contents, which are stored in the main memory 113 when the system shifts to the sleep state, are held even in the sleep state by applying the auxiliary standby power supply voltage Vstb_aux to the backup unit 184 from the standby power supply unit 172.

The standby power supply unit 173 operates at all times, and transforms a voltage, which is applied from the battery 181 or AC adapter 182, into a standby power supply voltage Vstb of a given level. The standby power supply voltage Vstb is applied to, for example, the EC/KBC 160 that needs to operate even when the system is in shutdown mode. Thus, for example, when the power button 13 is turned on in the shutdown mode of the system, the EC/KBC 160 can detect the turn-on to drive the system power supply unit 171 and auxiliary standby power supply unit 172.

The EC/KBC 160 has a voltage monitoring function of monitoring the voltage applied from the battery 181 and AC adapter 182. The EC/KBC 160 also has a power management function of managing the power supply circuit 170. The EC/KBC 160 also has a network controller power control function of controlling the application of the power supply voltage (network controller power supply voltage Vstb_lan) to the network controller 150, on the basis of the results of voltage monitoring, the operating states of the system, and the operating states of the system management function. In the present embodiment, the EC/KBC 160 controls the application of the network controller power supply voltage Vstb_lan to the network controller 150. In other words, the EC/KBC 160 controls the ON/OFF of the network controller power supply voltage Vstb_lan (the power supply of the network controller 150), using a control signal S1.

The EC/KBC 160 has state registers 161 and 162. The state register 161 is a state holding device for holding flag information f1 indicative of the ON/OFF state of the power supply of the network controller 150. The state register 162 is a state holding device for holding flag information f2 indicative of the operating state (enabling or disabling state) of the system management function. Whenever the system unit 183 notifies the EC/KBC 160 of information F, the EC/KBC 160 updates the flag information f2 to indicate the latest operating state of the system management function on the basis of information F. The flag information f1 and flag information f2 can be held in a single state register.

The output (positive electrode) of the auxiliary standby power supply unit 172 is connected to the network controller 150 via the switch 174. The switch 174 is an FET switch that is composed of a field effect transistor (FET), for example. The switch 174 is turned on/turned off in response to active or inactive control signal S1 output from the EC/KBC 160. During the output of the active control signal S1 from the EC/KBC 160, the auxiliary standby power supply voltage Vstb_aux output from the auxiliary standby power supply unit 172 is applied to the network controller 150 as the network controller power supply voltage Vstb_lan through the switch 174.

FIG. 3 is a block diagram of a configuration of a network system incorporating the computer (personal computer) 10 shown in FIG. 1. Referring to FIG. 3, the network controller 150 of the computer 10 is connected to another computer, for example, a system management console 30, via the network 20. While the power supply of the network controller 150 is in an ON state, the system management console 30 can operate the computer 10 by remote control using the system management function of the network controller 150.

FIG. 4 systematically shows a relationship among the operation of each of the system power supply unit 171, auxiliary standby power supply unit 172, and standby power supply unit 173 in the power supply circuit 170, the operating state of the system (system operating state) as a condition for operating these units, and the operating state (enabling/disabling state) of the system management function as a condition for operating these units. In FIG. 4, sign ◯ indicates that a unit is operating and sign × indicates that a unit is not operating.

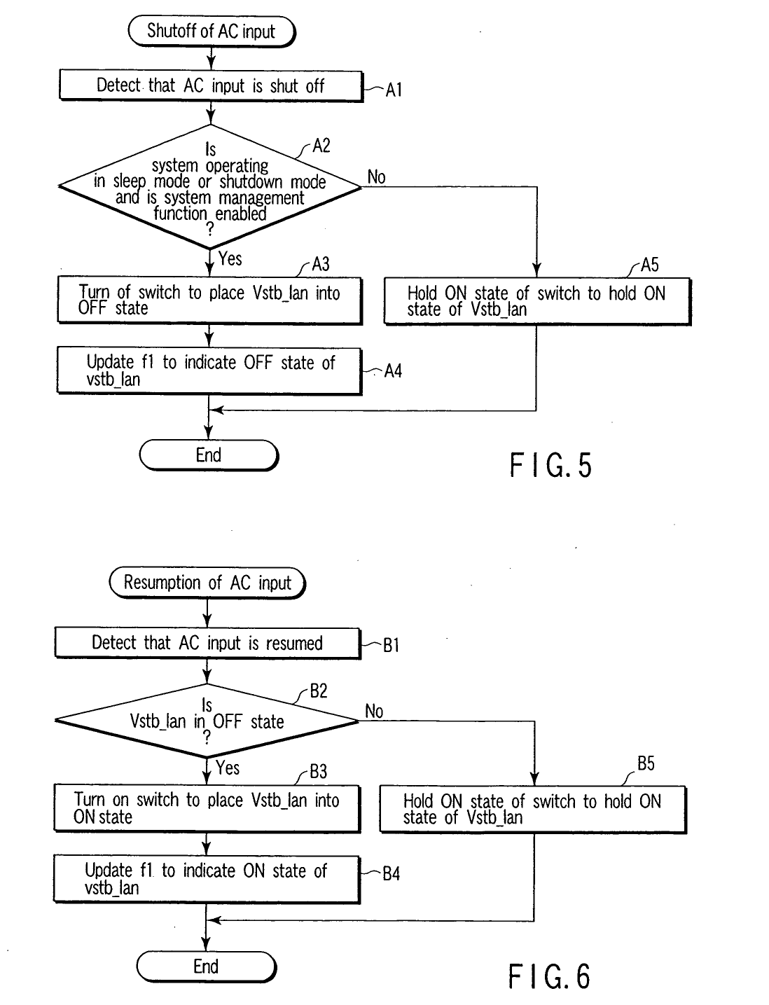

The operation of the present embodiment will be described with reference to the flowcharts of FIGS. 5 and 6, taking as examples the procedures of the EC/KBC 160 executed when the power supply voltage from the AC adapter 182 is shut off and when the power supply voltage is resupplied. Assume now that the plug of the AC adapter 182 is removed from the outlet of the AC power supply and consequently the power supply voltage input to the AC adapter 182 (AC input) is shut off. In block A1 of FIG. 5, the EC/KBC 160 monitors the voltage output from the AC adapter 182 to detect that the power supply voltage from the AC adapter 182 is shut off, or AC input is shut off. In this state, the computer 10 is driven by the battery 181 (battery power supply). The fact that the EC/KBC 160 monitors the voltage output from the AC adapter 182 is equivalent to monitoring whether the computer 10 is driven by the AC power supply or by the battery 181 (battery power supply).

When the EC/KBC 160 detects that the AC input is shut off, it determines that the computer 10 is not driven by the AC power supply. In other words, the EC/KBC 160 determines that the computer 10 is driven by the battery 181. In this case, in block A2, the EC/KBC 160 determines whether the system operating state is in sleep mode or shutdown mode and the system management function is enabled. Whether the system operating state is in sleep mode or shutdown mode is determined in response to the state of the control signal S2 supplied from the system unit 183. On the other hand, whether the system management function is enabled is determined on the basis of the flag information f2 held in the state register 162.

If the system (system operating state) is in sleep mode or shutdown mode and the system management function is enabled (active), the EC/KBC 160 inactivates (deasserts) the control signal S1 and thus turns off the switch 174 in block A3. When the switch 174 is turned off, the auxiliary standby power supply voltage Vstb_aux, which is supplied from the auxiliary standby power supply unit 172, is inhibited from being applied to the network controller 150 as a network controller power supply voltage Vstb_lan. In other words, the network controller power supply voltage Vstb_lan (network controller power supply) is shut off.

When the switch 174 is turned off, the EC/KBC 160 updates the flag information f1 held in the state register 161 to indicate the OFF state of the network controller power supply (OFF of Vstb_lan) in block A4.

If the network controller power supply voltage Vstb_lan is shut off, the network controller 150 is forcibly stopped to operate. Thus, even though the network controller 150 is formally set in an ON (enabled) state by the system management function and the computer 10 is driven by the battery 181, the network controller 150 can be prevented from consuming power. As described above, in the present embodiment, the power supply of the network controller 150, which is active even when the system is in sleep or shutdown mode, is turned off if the computer 10 is driven by the battery 181. For this reason, the power consumption of the battery 181 can be reduced more efficiently than the case where the network controller 150 is in the substantial ON state in which it can always operate.

On the other hand, if the system is neither in sleep mode nor in shutdown mode, or in normal mode (block A2), the EC/KBC 160 performs the process of block A5. Even though the system is in sleep mode or shutdown mode, if the system management function is disabled (block A2), the EC/KBC 160 performs the process of block A5. In block A5, the EC/KBC 160 holds the control signal S1 in active state and holds the ON state of the switch 174.

If the auxiliary standby power supply unit 172 is operating when the ON state of the switch 174 is held, the network controller power supply voltage Vstb_lan is applied to the network controller 150 as before the AC input is shut off. The network controller 150 can thus be used in, for example, the normal mode. On the other hand, the system management function is disabled in sleep mode or shutdown mode and thus the network controller 150 is in an OFF state. Even if the network controller power supply voltage Vstb_lan is applied to the network controller 150, no power is consumed by the network controller 150. In the computer 10, if the network controller 150 supports the Wake-On-LAN function as well as the system management function, the network controller 150 is turned off when the Wake-On-LAN function and system management function are both disabled in this computer 10.

An operation performed when a power supply voltage is resupplied from the AC adapter 182 will be described below. Assume that the plug of the AC adapter 182 is inserted into the outlet of the AC power supply and consequently an AC power supply voltage is resupplied to the AC adapter 182 (AC input is resumed). In other words, assume that the state in which the computer 10 is driven by the battery 181 is shifted to the state in which it is driven by the AC power supply.

In block B1, the EC/KBC 160 monitors the voltage output from the AC adapter 182 and thus detects that the power supply voltage is resupplied from the AC adapter 182, or the AC input is resumed. In this state, the computer 10 is driven by the power supply voltage from the AC adapter 182.

When the EC/KBC 160 detects that the AC input is resumed in block B1, it determines that the computer 10 is driven by the AC power supply. In this case, in block B2, the EC/KBC 160 determines whether the network controller power supply voltage Vstb_lan is turned off referring to the flag information f1 held in the state register 161.

If the network controller power supply voltage Vstb_lan is in an OFF state, the EC/KBC 160 activates (asserts) the control signal S1 and turns on the switch 174 in block B3. When the switch 174 is turned on, the auxiliary standby power supply voltage Vstb_aux is applied from the auxiliary standby power supply unit 172 to the network controller 150 as a network controller power supply voltage Vstb_lan. In other words, the network controller power supply voltage Vstb_lan (network controller power supply) is turned-on. When the switch 174 is turned on, the EC/KBC 160 updates the flag information f1 held in the state register 161 to indicate the ON state of the network controller power supply voltage Vstb_lan (the ON of the network controller power supply).

On the other hand, if the network controller power supply voltage Vstb_lan is not turned off, or if it is turned on, the EC/KBC 160 holds the control signal S1 in active state and holds the ON state of the switch 174. In other words, the EC/KBC 160 holds the ON state of the network controller power supply voltage Vstb_lan.

According to the above embodiment, the auxiliary standby power supply voltage Vstb_aux that is supplied from the auxiliary standby power supply unit 172, is used as the network controller power supply voltage Vstb_lan. However, the standby power supply voltage Vstb supplied from the standby power supply unit 173 can be used as the network controller power supply voltage Vstb_lan.

It is assumed in the above embodiment that the network controller 150 supports only the system management function. However, the network controller 150 can support only the Wake-On-LAN function or both the Wake-On-LAN function and the system management function. If necessary, the system management function described above can be replaced with the Wake-On-LAN function or both the Wake-On-LAN and the System management function.

While certain embodiments of the inventions have been described, these embodiments have been presented by way of example only, and are not intended to limit the scope of the inventions. Indeed, the novel apparatuses and methods described herein may be embodied in a variety of other forms; furthermore, various omissions, substitutions are changes in the form of the apparatuses and method described herein may be made without departing from spirit of the inventions. The accompanying claims and their equivalents are intended to cover such forms or modifications as would fall within the scope and spirit of the inventions.

What is claimed is:

1. An information processing apparatus including a network controller, comprising:
a power supply circuit configured to normally generate a plurality of power supply voltages, which are to be used in the information processing apparatus, from a direct-current power supply voltage generated from an alternating-current power supply by an alternating-current adapter and to generate the power supply voltages from a battery power supply when the alternating-current power supply is shut off, the power supply voltages including a specific power supply voltage to be used in the network controller; and
a power supply controller configured to control the power supply circuit to inhibit the specific power supply voltage from being applied to the network controller if the alternating-current power supply is shut off while a system operating state of the information processing apparatus is one of a sleep state and a shutdown state.

2. The information processing apparatus according to claim 1, wherein:
the network controller includes a system management function necessary for operating the information processing apparatus by remote control through a network and the network controller; and
the power supply controller controls the power supply circuit to inhibit the specific power supply voltage from being applied to the network controller if the alternating-current power supply is shut off while the system management function of the network controller is in an enable state as well as while the system operating state of the information processing apparatus is one of the sleep state and the shutdown state.

3. The information processing apparatus according to claim 2, further comprising:
first state notification means for notifying the power supply controller of the system operating state; and
second state notification means for notifying the power supply controller of an enable state using the network controller when the system management function is placed into the enable state and a disable state not using the network controller when the system management function is placed into the disable state,
wherein:
the power supply controller includes a state holding device which holds flag information indicating a latest state of the system management function of which the second state notification means notifies the power supply controller; and
the power supply controller determines whether the system operating state of the information processing apparatus is one of the sleep state and the shutdown state and whether the system management function is in the enable state, based on the system operating state of which the first state notification means notifies the power supply controller and a state of the system management function indicated by the flag information held by the state holding device, when the alternating-current power supply is shut off.

4. The information processing apparatus according to claim 1, wherein:
the network controller includes a Wake-On-LAN function necessary for powering on/powering off the information processing apparatus through a network and the network controller; and
the power supply controller controls the power supply circuit to inhibit the specific power supply voltage from being applied to the network controller if the alternating-current power supply is shut off while the Wake-On-LAN function of the network controller is in an enable state as well as while the system operating state of the information processing apparatus is one of the sleep state and the shutdown state.

5. The information processing apparatus according to claim 4, further comprising:
first state notification means for notifying the power supply controller of the system operating state; and
second state notification means for notifying the, power supply controller of an enable state using the network controller when the Wake-On-LAN function is placed into the enable state and a disable state not using the network controller when the Wake-On-LAN function is placed into the disable state,
wherein:
the power supply controller includes a state holding device which holds flag information indicating a latest state of the Wake-On-LAN function of which the second state notification means notifies the power supply controller; and
the power supply controller determines whether the system operating state of the information processing apparatus is one of the sleep state and the shutdown state and whether the Wake-On-LAN function is in the enable state, based on the system operating state of which the first state notification means notifies the power supply controller and a state of the Wake-On-LAN function indicated by the flag information held by the state holding device, when the alternating-current power supply is shut off.

6. The information processing apparatus according to claim 1, wherein the power supply controller controls the power supply circuit such that the specific power supply voltage is applied to the network controller when the alternating-current power supply is resumed.

7. The information processing apparatus according to claim 6, wherein:
the power supply circuit includes a switch which applies the specific power supply voltage to the network controller while the switch is in an ON state; and
the power supply controller turns off the switch to inhibit the specific power supply voltage from being applied to the network controller and turns on the switch to apply the specific power supply voltage to the network controller.

8. A method of controlling application of a power supply voltage to a network controller in an information processing apparatus, the information processing apparatus including a power supply circuit configured to normally generate a plurality of power supply voltages, which are to be used in the information processing apparatus, from a direct-current power supply voltage generated from an alternating-current power supply by an alternating-current adapter and to generate the power supply voltages from a battery power supply when the alternating-current power supply is shut off, the power supply voltages including a specific power supply voltage to be used in the network controller, the method comprising:
detecting a first state in which the information processing apparatus is driven by the battery power supply;
determining whether a system operating state of the information processing apparatus is a second state corresponding to one of a sleep state and a shutdown state when the first state is detected; and
controlling the power supply circuit to inhibit the specific power supply voltage from being applied to the network controller when it is determined that the system operating state is the second state.

9. The method according to claim 8, further comprising:
detecting that the information processing apparatus shifts from the first state to a third state in which the information processing apparatus is driven by the alternating-current power supply; and
controlling the power supply circuit to apply the specific power supply voltage to the network controller when it is detected that the information processing apparatus shifts to the third state.
